(19) United States
(12) Patent Application Publication
(10) Pub. No.: US 2017/0083699 A1
(43) Pub. Date: Mar. 23, 2017

(54) DYNAMIC INLINE ASSISTANCE MESSAGING

(71) Applicant: CHARTER COMMUNICATIONS OPERATING, LLC, St. Louis, MO (US)

(72) Inventors: Daniel Zagorski, Denver, CO (US); Srikanth Rapol, Denver, CO (US)

(73) Assignee: CHARTER COMMUNICATIONS OPERATING, LLC, St. Louis, MO (US)

(21) Appl. No.: 14/863,005

(22) Filed: Sep. 23, 2015

(51) Int. Cl. G06F 21/46

(52) U.S. Cl. CPC G06F 21/46

(57) ABSTRACT

A method, apparatus and software-related product for substantially real-time assistance for entering secure information such as a password in which dynamically and logically relevant hints/instructions may be displayed to a user during a secure information entry procedure.

### FIELD OF THE INVENTION

The invention relates to information security, more particularly but not exclusively, dynamic inline real-time assistance for entering secure information such as a password.

### BACKGROUND

Passwords provide the first line of defense against unauthorized access to a computer. The stronger a password, the more protected the computer will be from hackers and malicious software. Every computer's user should make sure to have a strong password for all accounts on the computer. For example, a strong password may include (but not being limited to) the following features:
at least eight characters long;
not containing your user name, real name, or company name;
not containing a complete word;
significantly different from previous passwords; and
containing characters from each of the following categories including: uppercase letters, lowercase letters, digits, and symbols (special characters).

Besides passwords, similar requirements may be applied to user names, security words, object names, and the like. The more frequently these special (confidential) words/passwords need to be changed for providing a better security, the more confusing a user may be to enter, for example, a password which was never used before and/or satisfying at least some of the above listed features in order to continue to have a strong password.

### SUMMARY

Various deficiencies in the prior art are addressed by using a method, apparatus and software related product according to embodiments disclosed herein provide a mechanism for constructing a password or other string of characters in accordance with a plurality of predefined rules. Various embodiments provide substantially real-time assistance for entering secure information such as a password in which dynamically and logically relevant hints/instructions may be displayed to a user such as during a secure information entry procedure.

A mechanism according to various embodiments may comprise receiving, by an electronic device through a user interface, a selection of one character for entering a string of characters, the string being constructed from a plurality of characters selected in accordance with one or more predefined rules; evaluating, by the electronic device, the selected one character together with any previously selected characters of the string of characters using the one or more predefined rules; and generating, by the electronic device, a user interface instruction signal comprising information for guiding a user to avoid selecting as a further character of the string of characters any member of a group of one or more characters indicated by the evaluation as breaking one or more of the predefined rules if selected.

### BRIEF DESCRIPTION OF THE DRAWINGS

The teachings of the present invention can be readily understood by considering the following detailed description in conjunction with the accompanying drawings, in which:

FIG. 1 is an example of a simplified block diagram of an electronic (computing) device for practicing exemplary embodiments of the invention.

FIGS. 2a and 2b are non-limiting examples of various designated areas on a display of an electronic device for practicing various embodiments.

FIGS. 3a-3f are non-limiting examples of displayed step-by-step instructions for selecting a string such as a password, according to various embodiments.

FIG. 4 is a non-limiting example of displayed instructions for selecting a string such as a password for a smaller area for displaying instructions, according to an embodiment.

FIG. 5 is a further non-limiting another example of displayed instructions for selecting a string such as a password, according to an embodiment.

FIG. 6 is a flow chart demonstrating implementation of embodiments described herein by an electronic (computing) device;

FIG. 7 shows a high-level block diagram of a computer device (electronic device) suitable for performing various embodiments described herein.

To facilitate understanding, identical reference numerals have been used, where possible, to designate identical elements that are common to the figures.

### DETAILED DESCRIPTION

According to various embodiments described herein, a method, apparatus and software related product (e.g., a computer readable memory or a storage device) are presented for dynamic inline real-time assistance for entering secure information such as a password. This is a way to dynamically and logically display relevant hints/instructions on an electronic device such as a computer, a mobile device, a wireless device, a tablet, a smart phone and the like. For example, when a user is creating a new password, displaying specific instructions/comments after one character is entered, but before a next character is selected, will direct a user to fulfill password requirements and select the appropriate character using such instructions (e.g., “please enter additional characters”, “password may not use special characters”, etc.). These instructions may provide to a user an immediately available feedback after entering each character of the string of characters to how select a next character. The string may be a password, a user name, an identification of a person or an object, an answer of a security question and the like.

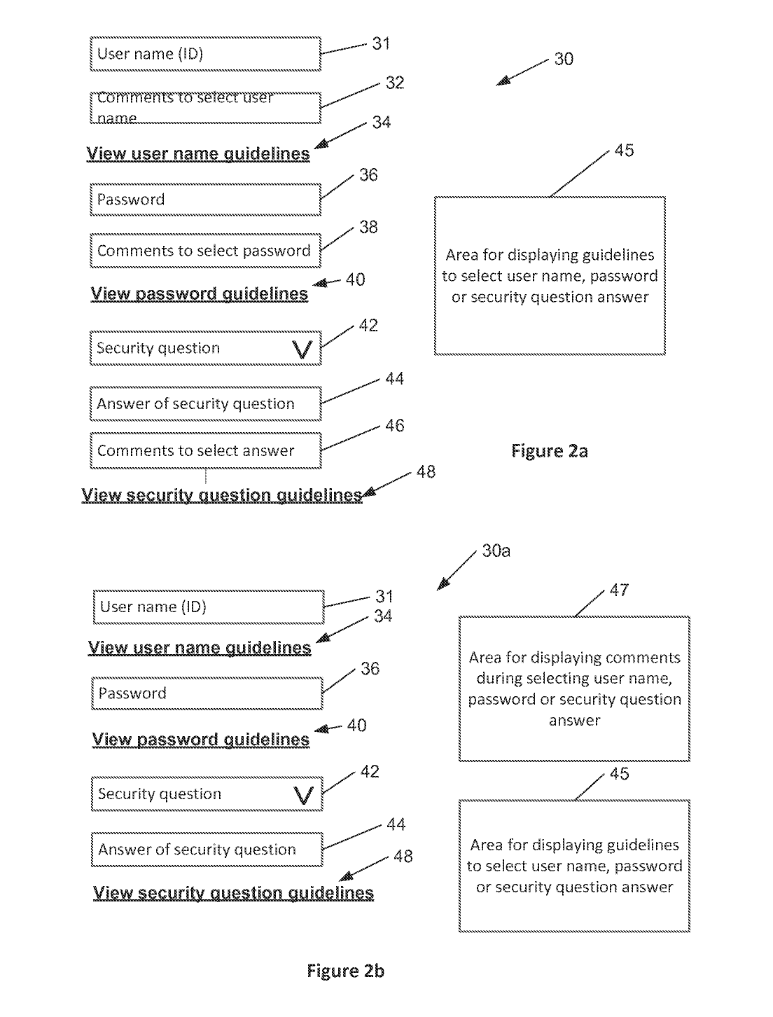

According to an embodiment, an electronic device (such as a computer or a wireless smart phone) is configured to receive through a user interface (e.g., a keyboard or a touch screen) a selection of one character for entering a string of characters (such as a password or a user name), the string being constructed from a plurality of characters selected based on one or more predefined rules. The received one character is displayed in a designated area (see FIGS. 2a and 2b for illustration) of a display of the electronic device for entering the string of characters (such as a password). The electronic device can be further configured to evaluate the one character together with, if previously received, one or more previously selected characters of the string in reference to one or more predefined rules.

According to various embodiments, each selected character in the string may be one of a lowercase letter, an uppercase letter, a digit, or a special character, subject to restrictions due to one or more predefined rules. The one or more predefined rules may include (but are not limited to) any of the following exemplary rules:

the string comprising at least one uppercase letter,

the string comprising any upper or lowercase letters,

the string comprises at least one special character,

the string does not comprise any special character,

the string comprises a specified minimum number of characters,

the string comprises a specified maximum number of characters,

the string comprises a specified minimum number of digits,

the string comprises a specified minimum number of letters,

the string does not comprise identical characters,

the string does not comprise adjacent identical characters,

the string does not contain your last or first name, user name or company name,

the string does not contain a full word, and

the string should have a predefined percentage of new characters relative to a previously used string(s), when updated.

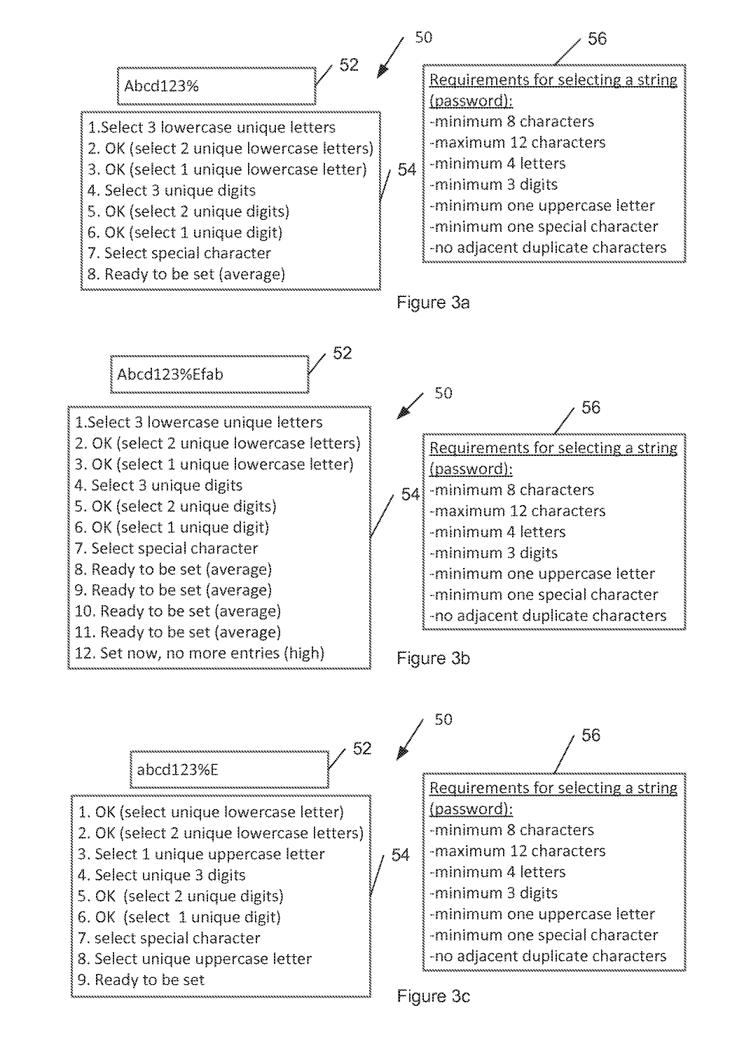

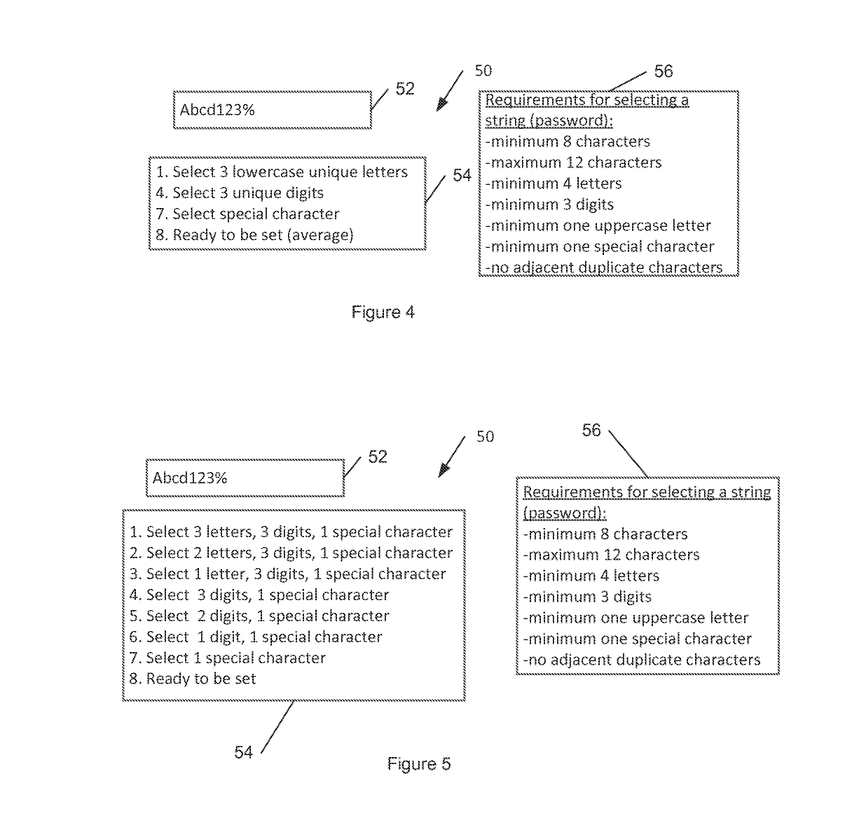

Moreover, in one scenario, if the evaluation indicates that all predefined one or more rules are not being broken after the selection of the one character, but assuming that at least one of the one or more predefined rules will be broken or over-performed in a next selection of a next character from at least one group of characters (see examples in FIGS. 3a-3e, 4 and 5), generating by the electronic device an instruction signal comprising information for helping a user in real time to enter a next selection of a next character to avoid selecting any character from the at least one group of characters. The instruction signal can also comprise one or more reminder signals in reference to further one or more characters yet to be entered (see a non-limiting example in FIG. 5).

It is noted that a term “broken” is used herein to indicate that a character has been selected in error. For example, if one of the predefined rules does not allow to select in the string any character more than one time, and if the selected character is the same as was entered previously, then this means that this one predefined rule is broken. However, if, for example, a selected character is a digit but the required number of letters in the string is not met yet (but it will be met later), then it does not mean that any of the predefined rules was broken when the selected digit is broken.

It is further noted that a term “over-performed” is used to indicate that a corresponding rule such as “the string should have a minimum of 4 letters” is exceeded. In other words, if 4 letters have been selected, and if in a next step a fifth letter is selected, then this rule of having minimum of 4 letters is “over-performed”.

Thus, one or more characters of a character string may have already been selected such that certain other characters normally available for selection would, if selected, violate one or more rules associated with the formation of the character string. In this case, those characters within the group of characters which would violate the one or more rules if selected (i.e., members of a violation group or next character rule violation group) may be identified for the user to avoid such selection. In various embodiments, selection of such characters may be ignored in that a message is immediately provided to the user in response to user entry of such a character. In various embodiments, detail messages with logic instructions, hints and the like are provided to the user via the user interface to avoid such selection. That is, those characters within a group of characters whose selection is a next character for the character string would violate the rules are indicated to the user as being non-selectable characters.

Furthermore, in another scenario, if the evaluation indicates an error, so that at least one of the one or more predefined rules is being broken after selection of the one character, the electronic device is configured to generate a re-enter signal comprising further information for helping a user to re-enter the one character and correct the error (see example in FIG. 3f). After re-entering a correct character, the evaluation is performed further as described herein to provide a corresponding instruction/hint for entering a next character to the string, as described herein.

In a further embodiment, if the evaluation indicates by assumption that none of predefined one or more rules have been broken after the selection of the one character, and assuming that none of the one or more predefined rules will be broken or over-performed in the next selection of character, the electronic device is configured to generate a confirmation signal. This confirmation signal may simply state “OK” (one option). In addition or alternatively, the confirmation signal may comprise an indication regarding remaining characters to be entered (see non-limiting examples in FIGS. 3a-3e).

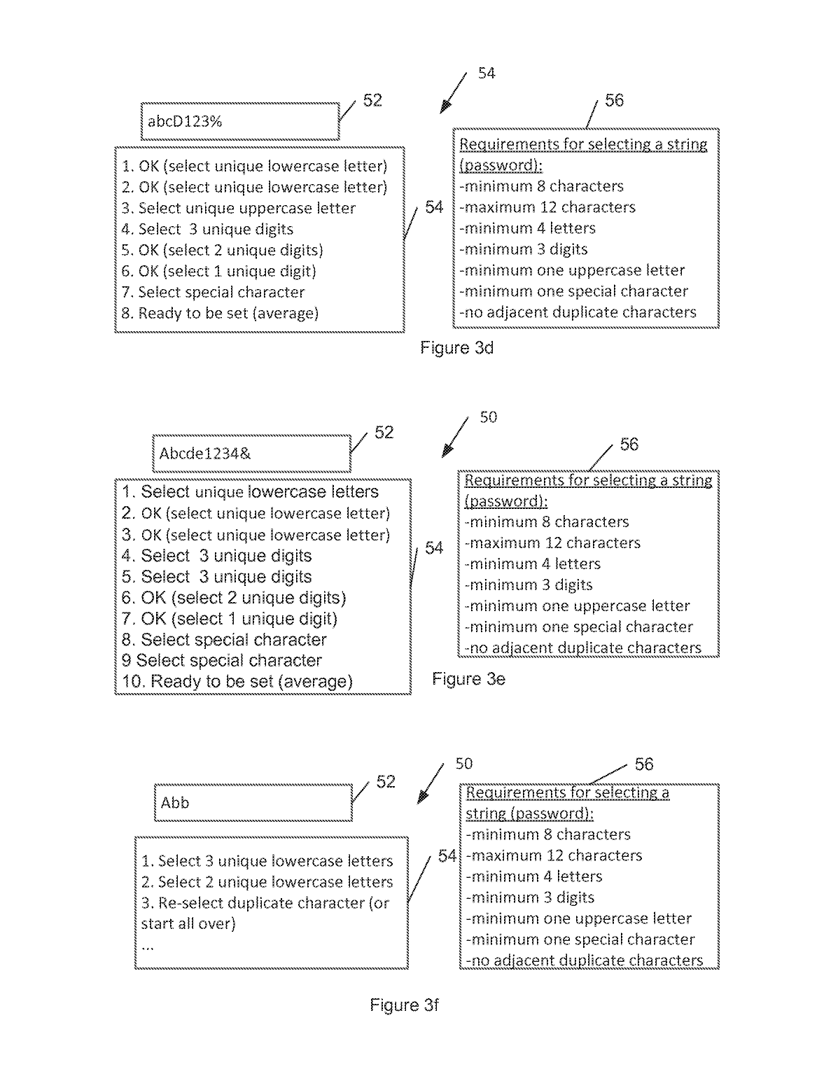

Alternatively, if the evaluation indicates that none of the predefined one or more rules have been broken after the selection of the one character and assuming that none of the one or more predefined rules will be broken or over-performed in the next selection, a signal may not be generated at all, i.e., subsequent displaying of the instruction may be skipped for the entered one character (see a non-limiting example in FIG. 4 for illustration). This “space saving” option may be used if the allocated area for comments in the display is small for displaying instructions/comments for all character selection steps. Also, according to another embodiment, in case of a limited space available in the display for instructions/comments (e.g., see areas 32, 38 and 46 in FIGS. 2a-2b), only one or two current/latest selection instructions may be displayed at a time to help the user to make a current selection.

According to another embodiment, if the evaluation indicates that all predefined one or more rules are being met after the selection of the one character, the electronic device is configured to generate a completion signal advising to set/elect the selected string of characters. This completion signal may comprise information about a security strength (e.g., low, average, or high) of the set/elected string of characters generated by the electronic device, as further demonstrated in non-limiting examples in FIGS. 3a-3e, 4 and 5.

Moreover, if a maximum number of characters in the string have been reached according to one of the one or more predefined rules and all the one or more rules have been met, the electronic device is configured to generate a mandatory set signal for setting/electing the selected string of characters. At this point, the user must set/elect the string which has been selected, or start the string selecting process from the beginning (if for example, the user still wants to improve security level to high).

Furthermore, according to other embodiment, the process of a) receiving the selection of the character, b) evaluating the selection in reference to the one or more predefined rules, and c) generating the instruction signal, can be repeated until the string is completed according to the one or more rules and elected. Moreover, the information in the instruction can comprise a number of every selected/evaluated character in the string, which may be displayed as a part of the instruction message as demonstrated in examples of FIGS. 3a-3f, 5 and 5. These figures also show further instruction information displayed in a designated area of a display of the electronic device (see FIGS. 2a and 2b), where the designated area is configured to accommodate one or more lines of text as further discussed herein in reference to FIGS. 2a-2b, 3a-3f, 5 and 5. The dedicated area may be located below or in a vicinity of an area where the string of characters is entered as demonstrated in FIGS. 2a-2b. Thus, each of the one or more lines of text may comprise the sequence number of a corresponding selected character in the string, and information for selecting a next character, both comprised in a corresponding instruction signal.

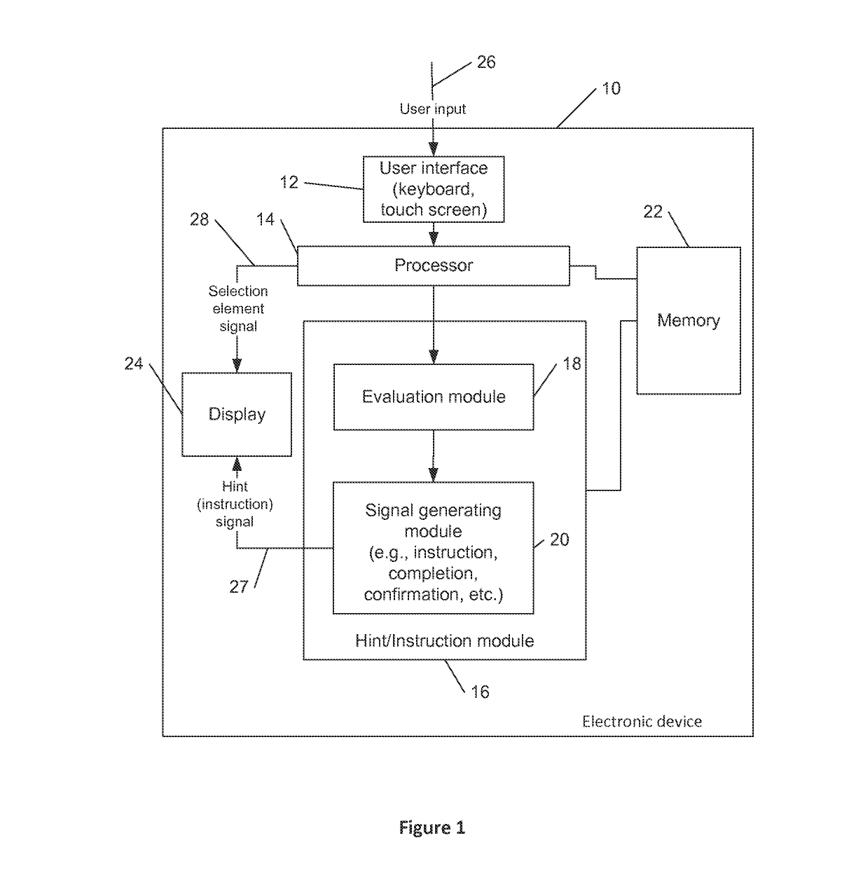

FIG. 1 shows an example of a simplified block diagram of an electronic device 10 for practicing exemplary embodiments of the invention. The electronic device 10 (e.g., a computer, a mobile device, a wireless device, a tablet, smart phone, etc.) comprises a hint/instruction module 16, at least one processor 14, at least one memory 22, at least one display 24 and at least one user interface 12.

The hint/instruction module 16 comprises a) an evaluation module 18 for evaluating each character after being entered the string of characters whether at least one of the one or more predefined rules for creating a string of characters is broken or can be broken or over-performed in a next step as described herein, and b) a signal generating module 20 for generating signals, such as instructions, completions, confirmations and the like, displayed on a display/screen of the electronic device 10 for guiding a user for entering next character(s) to the string, correcting a character entered in error, or electing the entered string of characters, as described herein.

A display 24 may be used for displaying the entered characters of the string and generated comment/instruction after entering each character in corresponding designated areas of the display 24. The user interface 12 can be a keyboard or a touch screen for entering a user selection of characters to be added to a string of interest (such a password, a user name and the like) based on one or more predefined rules. In one embodiment the touch screen can be a part of the display 24.

Various embodiments of the at least one memory 22 (e.g., computer readable memory) may include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the processor 14 include but are not limited to general purpose computers, special purpose computers, microprocessors, digital signal processors (DSPs) and multi-core processors.

The hint/instruction module 16 or each of the modules 18 and 20 may be implemented as an application computer program stored, e.g., in the at least one memory 22, but in general it may be implemented as a software, a firmware and/or a hardware module or a combination thereof. In particular, in the case of software or firmware, one embodiment may be implemented using a software related product such as a computer readable memory (e.g., a non-transitory computer readable memory), computer readable medium or a computer readable storage structure comprising computer readable instructions (e.g., program instructions) using a computer program code (i.e., the software or firmware) thereon to be executed by a computer processor.

Furthermore, the module 16, 18 or 20 can be implemented as a separate block, or can be combined with another module/block in the electronic device 10, or can be split into several blocks according to their functionality. Moreover, it is noted that all or selected modules of the module 16 can be implemented using an integrated circuit (e.g., using an application specific integrated circuit, ASIC).

FIGS. 2a and 2b show non-limiting examples of various designated areas on a display 30 of an electronic device for practicing various embodiments described herein.

In FIGS. 2a and 2b, areas 31, 36 and 44 are designated for entering user selection of characters to a corresponding string: a password in the area 31, a user name in the area 36 and an answer of security question in the area 44, as described herein. Areas 34, 40 and 48 are provided to facilitate viewing the corresponding rules for entering the password in the area 34, the corresponding rules for entering the user name in the area 40, and the corresponding rules for entering the answer of security question in the area 48, The corresponding rules can be displayed in a designated area 45 when a cursor (or a finger in case of a touch screen) is moved to the area 34, 40 or 48 and clicked on or hovered over the corresponding area 34, 40 and 48. An area 42 is for a conventional choosing of a security question.

In FIG. 2a, areas 32, 38 and 46 (located below corresponding areas 31, 36 and 44) are designated for entering the generated comments/instructions described herein to guide a user to enter next character(s) to the string, correct a character entered in error, or elect the entered string of characters, as described herein. As shown in FIG. 2a, the area 32, 38 or 46 may accommodate one or maybe two lines of comments. Therefore, the area 32, 38 or 46 can be used primarily for displaying a current instruction/comment after entering one character to guide the user to enter the next character. After the next character is entered, the area 32, 38 or 46 can display instruction/comment after entering the next character, and so on.

In FIG. 2b, instead of using three relatively small separate areas 32, 38 and 46 as in FIG. 2a, one larger area 47 can be allocated to enter generated comments/instructions for any of the entering strings area 31, 36 or 44 (which is currently entered) to guide a user to select for entering next character(s) to the corresponding string, correct a character entered in error, or elect the entered string of characters, as described herein. The larger area 47 can simultaneously show instruction/comments for several or all entered characters simultaneously.

FIGS. 3a-3f, 4 and 5 demonstrate various non-limiting examples of selecting a string such as a password in the area 52 of a display 50 based on a requirement list shown in an area 56, and displayed instruction/comments generated after each selection of the character in real time (to provide instructions for the next character selection). The requirements (referred herein as to “one or more predefined rules”) for selecting an appropriate string of characters are displayed in the area 56 and include the following:
minimum 8 characters,
maximum 12 characters,
minimum 4 letters,
minimum 3 digits,
minimum one uppercase letter,
minimum one special character, and
no duplicate characters.

Instructions/comments after each selection of character is displayed in an area 54, where each instruction line starts with a number identifying an order number of selected character in the string.

In FIG. 3a a first selected character is an uppercase “A”. Since only one uppercase character is required in the password (according to one of the predefined rules), the corresponding comment on a first line in the area 54 after the first character is selected states: “1. Select 3 unique lowercase letters”. A term “unique” is optional and used in the instruction because no identical characters are allowed according to the one or more rules, but the term “unique” may be omitted if a size of the area 54 is not large enough to display it. Thus, the instruction/hint to the user after the first selection is to select a lowercase letter in a next (second) step.

Then in the second step, the user selects a unique lowercase letter “b”. Since only two letters (A and b) are selected at this point, and assuming that none of the predefined rules have been or will be broken or over-performed in the current and next selection respectively, the corresponding comment/confirmation on a second line in the area 54 (after the second character has been selected) states: “2. OK (select 2 unique lowercase letters)”. As discussed herein, the statement in parenthesis is optional.

Then in the third step, the user selects a unique lowercase letter “c”. Since only three letters (A, b and c) are selected at this point, and assuming that none of the predefined rules have been or will be broken or over-performed in the current and next selections respectively, the corresponding comment/confirmation on a third line in the area 54 (after the third character is selected) states as follows: “3. OK (select 1 unique lowercase letter)”.

Then in the fourth step, the user selects a unique lowercase letter “d”. Since the required minimum of four letters (A, b, c and d) is achieved at this point, and that none of the predefined rules have been broken, the corresponding instruction/hint on a fourth line in the area 54 (after the fourth character is selected) states as follows: “4. Select 3 unique digits”.

Then in the fifth step, the user selects a unique digit “1”. Since only one digit (1) is selected at this point, and assuming that none of the predefined rules have been or will be broken or over-performed in the current and next selections respectively, the corresponding comment (confirmation) on a fifth line in the area 54 after the fifth character is selected states: “5. OK (select 2 unique digits)”.

Then in the sixth step, the user selects a unique digit “2”. Since only two digits (1 and 2) are selected at this point, and assuming that none of the predefined rules have been or will be broken or over-performed in the current and next selections respectively, the corresponding comment/confirmation on a sixth line in the area 54 (after the sixth character is selected) states as follows: “6. OK (select 1 unique digit)”.

Then in the seventh step, the user selects a unique digit “3”. Since the required minimum of four letters (1, 2 and 3) is achieved at this point, and none of the predefined rules have been broken, the corresponding instruction (hint) on a seventh line in the area 54 after the seventh character is selected states as follows: “7. Select special character”.

Then in the eighth step, the user selects a special character “%”. Since the required minimum of one special character is achieved at this point, and none of the predefined rules have been broken, the corresponding instruction (completion) on a eighth line in the area 54 (after the eighth character is selected) states as follows: “8. Ready to be set (average)”. The security strength (e.g., low, average, and high) of the entered string of characters is indicated in parenthesis as being “average”.

After the last (8^{th}) instruction, the user elects (set) the string and the procedure ends.

Many variations of the exemplary character selection of the described instruction-generated procedure are illustrated by other non-limiting examples in FIGS. 3b-3f, 4 and 5.

FIG. 3b shows a similar selection process as in FIG. 3a. The only difference is that after ascertaining in eighth instruction that the security level to be average, the user continues to select more unique uppercase and lowercase letters “EfCh” in attempt to increase the security level of the string. When the twelfth character (h) is selected, the security strength jumps to a desired “high” level. Coincidently, the twelve selection of character is the last character (maximum twelve is allowed), so that the corresponding instruction (completion) on a twelfth line in the area 54 after the twelfth character is selected states as follows: “12. Set now, no more entries (high)”.

FIG. 3c demonstrates another exemplary embodiment similar to the one shown in FIG. 3a. Here, the difference with FIG. 3a is that first four selected characters are lowercase letters in spite of the instruction provided to the user after selection of the third character (“3. Select unique uppercase letter”). Therefore, after the eighth selection, the instruction (provided in the area 54) suggests to enter a unique uppercase letter again. In ninth selection the user follows the instruction and enters the unique upper letter “E”, so that the total number of selected elements is nine which are elected after instruction “9. Ready to be set (average)”.

FIG. 3d demonstrates another exemplary embodiment similar to the one shown in FIGS. 3a and 3c. In this example, first three selected characters are unique lowercase letters and then the fourth selected character is a unique uppercase letter “D” per instruction (provided in the area 54) after the third character is selected stating as follows: “3. Select unique uppercase letter”. In this case, the user complies with this instruction, whereas in the example of FIG. 3c the user did not comply with this instruction.

FIG. 3e demonstrates another exemplary embodiment similar to the one shown in FIGS. 3a and 3c. Here, the difference with FIG. 3a is that the user does not comply with the instruction after selection of the fourth character stating “4. Select 3 unique digits” and selects instead a lowercase letter “e”. Also, the user does not comply with the instruction after selection of the eighth character stating “8, Select special character” and selects a digit “4” instead of the special character. As a result of this deviation from the provided instructions, the string has 10 characters (instead of 8 or 9) which is longer but does not provide better security strength.

FIG. 3f is a simple illustration of the user making a mistake by selecting the same lowercase letter “b” twice, so that the user must to correct the third selected character or start entering characters from the start of the string. It is noted that this type of user assistance can be especially beneficial under rule (which is not used in the current example in FIG. 3f) stating that “the string should have a predefined percentage of new characters relative to a previously used string(s), when updated”. This is because it is hard for any user to remember and compare with all characters selected in the previously elected password(s). Then computerized assistance for selecting characters may be not only useful but necessary.

Furthermore, FIGS. 4 and 5 demonstrate alternative instructions which can be provided for the string like in the example of FIG. 3a.

In FIG. 4, a certain steps (which may be less important) can be skipped, so that the instructions are only displayed after selecting characters 1, 4, 7 and 8. This may be useful if an allocated display space for the area 54 is not enough to display all steps.

In FIG. 5 shows an alternative way to provide instructions, wherein each entry lists how many characters of different types are left to be selected in the following steps after each selection step in the string to meet the requirement (one or more predefined rules) listed in the area 56.

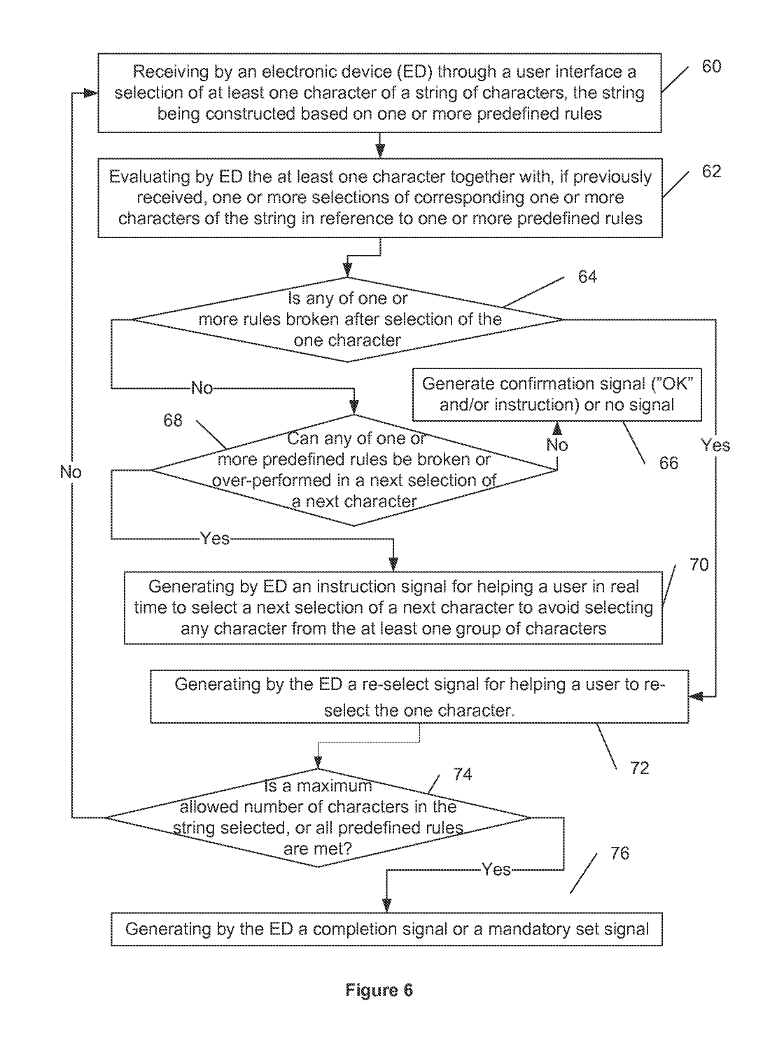

With reference now to FIG. 6, shown is an exemplary flow chart demonstrating implementation of embodiments described herein for dynamic inline real-time assistance for entering secure information such as a password by an electronic device (ED), e.g., a computer, a mobile device, a wireless device, a tablet, a smart phone and the like.

It is noted that the order of steps shown in FIG. 6 is not required, so in principle, the various steps may be performed out of the illustrated order. Also certain steps may be skipped, different steps may be added or substituted, or selected steps or groups of steps may be performed in a separate application following the embodiments described herein.

In a method according to the embodiment shown in FIG. 6, in a first step 60, the electronic device (ED) is configured to receive, through a user interface (a keyboard or a touch screen) a selection of at least one character of a string of characters, the string being constructed based on one or more predefined rules.

In a next step 62, the ED is configured to evaluate the at least one character together with, if previously received, one or more selections of corresponding one or more characters of the string in reference to the one or more predefined rules.

In a next step 64, the ED is configured to ascertain whether any of one or more rules broken after selection of the one character. If it is ascertained that at least one rule was broken and the one character is selected in error, in step 72 the ED is configured to generate by the ED a re-enter signal for helping a user to re-enter the one character.

If, however, it is ascertained (by assumption) that none of one or more rules were broken, in a next step 68, the ED is configured to ascertain (by assumption) whether any of the one or more predefined rules can be broken or over-performed in a next selection of a next character. If that is not the case, in step 66, the ED is configured to generate a confirmation signal (“OK” and/or instruction for entering a next character) or no signal, and the process goes to step 74.

If however, it is ascertained (by assumption) that at least one of the one or more predefined rules can be broken or over-performed in a next selection of a next character from at least one group of characters, in a next step 70, the ED is configured to generate an instruction signal comprising information for helping a user in real time to enter a next selection of a next character to avoid selecting any character from the at least one group of characters. Then the process goes to step 74.

In step 74, the ED is configured to ascertain whether all predefined rules have been met and/or whether a maximum allowed number of characters in the string have been selected. If that is true, in a next step 76, the ED is configured to generate a completion signal or a mandatory set signal, as described herein. However, if it is ascertained that not all predefined rules have been met and/or a maximum allowed number of characters in the string have not been selected, the process goes back to step 60.

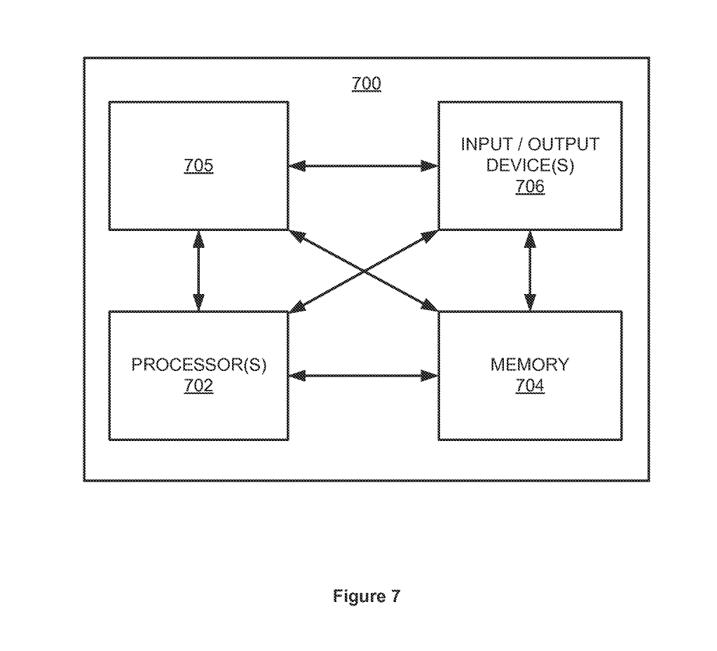

FIG. 7 depicts a high-level block diagram of a computing device 700 suitable for use in performing various functions described herein with respect to the disclosed embodiments, such for implementing any device like device 10 as described above with respect to the various figures. FIG. 7 is a simplified block diagram of a computing/electronic device that is suitable for practicing the exemplary embodiments of this invention, and a specific manner in which components of the device are configured to cause that device to operate.

As depicted in FIG. 7, computer (computing device) 700 includes a processor element 703 (e.g., a central processing unit (CPU) and/or other suitable processor(s)), a memory 704 (e.g., random access memory (RAM), read only memory (ROM), and the like), a cooperating module/process 705, and various input/output devices 706 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like).

It will be appreciated that the functions depicted and described herein may be implemented in hardware and/or in a combination of software and hardware, e.g., using a general purpose computer, one or more application specific integrated circuits (ASIC), and/or any other hardware equivalents. In one embodiment, the cooperating process 705 can be loaded into memory 704 and executed by processor 702 to implement the functions as discussed herein. Thus, cooperating process 705 (including associated data structures) can be stored on a computer readable storage medium, e.g., RAM memory, magnetic or optical drive or diskette, and the like.

It will be appreciated that computing device 700 depicted in FIG. 7 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computing device, adapt the operation of the computing device, such that the methods and/or techniques described herein are invoked or otherwise provided. Instructions for invoking the inventive methods may be stored in tangible and non-transitory computer readable medium such as fixed or removable media or memory, and/or stored within a memory within a computing device operating according to the instructions.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

The various embodiments contemplate an apparatus configured to provide functions in accordance with the various embodiments, the apparatus comprising a processor and a memory communicatively connected to the processor, the processor configured to perform these functions as described above with respect to the various figures.

In describing alternate embodiments of the apparatus claimed, specific terminology is employed for the sake of clarity. The invention, however, is not intended to be limited to the specific terminology so selected. Thus, it is to be understood that each specific element includes all technical equivalents that operate in a similar manner to accomplish similar functions.

It is to be understood that the foregoing description is intended to illustrate and not to limit the scope of the invention, which is defined by the scope of the appended claims. Other embodiments are within the scope of the following claims.

It is noted that various non-limiting embodiments described herein may be used separately, combined or selectively combined for specific applications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method, comprising:
receiving, by an electronic device through a user interface, a selection of one character for entering a string of characters, the string being constructed from a plurality of characters selected in accordance with one or more predefined rules;
evaluating, by the electronic device, the selected one character together with any previously selected characters of the string of characters using the one or more predefined rules; and
generating, by the electronic device, a user interface instruction signal comprising information for guiding a user to avoid selecting as a further character of the string of characters any member of a group of one or more characters indicated by the evaluation as breaking one or more of the predefined rules if selected.

2. The method of claim 1, wherein said receiving, evaluating and generating is repeated for each selected character of the string of characters.

3. The method of claim 1, wherein the information in the instruction signal comprises a number of the one character in the string.

4. The method of claim 1, further comprising:
generating, by the electronic device, a user interface instruction signal comprising information guiding the user to reenter the selected one character if the evaluation indicates that any of the predefined one or more rules will be broken after receiving the selected one character.
generating, by the electronic device, a user interface instruction signal comprising information for guiding a user to avoid selecting as a further character of the string of characters any member of a group of one or more characters indicated by the evaluation as breaking one or more of the predefined rules if selected.

5. The method of claim 1, wherein:
receiving, by an electronic device through a user interface, a further selection of one character for entering a string of characters;
evaluating by the electronic device the further received character together with any previously selected characters of the string of characters using the one or more predefined rules; and
generating by the electronic device a user interface instruction signal comprising information guiding the user to reenter the further received character if the evaluation indicates that any of the predefined one or more rules will be broken by the further received character.

6. The method of claim 1, wherein the selection is a single-action selection.

7. The method of claim 1, wherein each selected character in the string is one of a lowercase letter, an uppercase letter, a digit, or a special character.

8. The method of claim 1, wherein the string of characters is a password, a user name, an identification of a person or an object, or an answer of security question.

9. The method of claim 1, wherein the one or more rules include any of the following rules:
the string comprising at least one uppercase letter,
the string comprising any upper or lowercase letters,
the string comprises at least one special character,
the string does not comprise any special character,
the string comprises a specified minimum number of characters,
the string comprises a specified maximum number of characters,
the string comprises a specified minimum number of digits,
the string comprises a specified minimum number of letters,
the string does not comprise identical characters,
the string does not comprise adjacent identical characters,
the string does not contain your last or first name, user name or company name,
the string does not contain a full word,
the string should have a predefined percentage of new characters relative to a previously used string, when updated.

10. The method of claim 1, wherein the information comprised in the instruction signal is displayed in a designated area of a display of the electronic device, the designated area is configured to display one or more lines of text, wherein the designated area is below or in a vicinity of an area where the string of characters being entered.

11. The method of claim 10, wherein each of the one or more lines of text comprises a sequence number of a corresponding selected character and information for selecting a next character, both comprised in a corresponding instruction signal.

12. The method of claim 1, wherein the method further comprises:
generating by the electronic device a user interface instruction signal comprising a confirmation signal if the evaluation indicates that none of the predefined one or more rules are broken by the received selected one character.

13. The method of claim 12, wherein the confirmation signal comprises an “OK” indication.

14. The method of claim 12, wherein the confirmation signal comprises an indication regarding remaining characters to be entered.

15. The method of claim 1, wherein the instruction signal comprises one or more reminders in reference to further one or more characters yet to be entered.

16. The method of claim 1, further comprising:
receiving by the electronic device through the user interface a further selection of one further character for entering the string of characters;
evaluating by the electronic device the one further received character together with any previously selected characters of the string of characters using the one or more predefined rules; and
generating, by the electronic device, a user interface instruction signal if evaluation indicates that the selection of the one further character for entering a string of characters would break one or more of the predefined rules character if the evaluation indicates that none predefined one or more rules, or if receiving an additional one further character for entering a string of characters would break one or more of the predefined rules.

17. The method of claim 16, wherein if the evaluation further indicates that all predefined one or more rules have been met after the selection of the one character, generating by the electronic device a completion signal advising to elect the selected string of characters.

18. The method of claim 16, wherein the completion signal comprises information about a security strength of the selected string of characters.

19. An apparatus comprising:
a processor;
a storage medium for tangibly storing thereon program logic for execution by the processor, the program logic comprising:
logic to receive by an electronic device through a user interface a selection of one character for entering a string of characters, the string being constructed from a plurality of characters selected in accordance with one or more predefined rules;
logic to evaluate by the electronic device the selected one character together with any previously selected characters of the string of characters using the one or more predefined rules; and
logic to generate by the electronic device an instruction signal comprising information for helping a user in real time for entering a next selection of a next character to avoid selecting as a next character any member of a group of one or more characters indicated by the evaluation as breaking a rule if selected.

20. A non-transitory computer readable storage medium tangibly storing computer program instructions capable of being executed by a computer processor, the computer program instructions defining code for:
receiving, by an electronic device through a user interface, a selection of one character for entering a string of characters, the string being constructed from a plurality of characters selected in accordance with one or more predefined rules;
evaluating, by the electronic device, the selected one character together with any previously selected characters of the string of characters using the one or more predefined rules; and
generating, by the electronic device, a user interface instruction signal comprising information for guiding a user to avoid selecting as a further character of the string of characters any member of a group of one or more characters indicated by the evaluation as breaking one or more of the predefined rules if selected.
